(19) United States
(12) Patent Application Publication
(10) Pub. No.: US 2022/0023951 A1
(43) Pub. Date: Jan. 27, 2022

(54) DEVICE AND METHOD FOR MEASURING POWDER BED DENSITY IN 3D PRINTING / ADDITIVE MANUFACTURING OPERATIONS

(71) Applicant: B3D PERFORMANCE INC., Montréal (CA)

(72) Inventors: Yao Yao DING, Montréal (CA); Jose Alberto MUNIZ LERMA, Montréal (CA); Mathieu BROCHU, Saint-Hubert (CA); Amit KUMAR, Montréal (CA); Tejas RAMAKRISHNAN, Montréal (CA)

(21) Appl. No.: 17/250,933

(22) PCT Filed: Sep. 17, 2020
(86) PCT No.: PCT/CA2020/051247

§ 371 Date: Mar. 30, 2021

Related U.S. Application Data
(60) Provisional application No. 62/901,842, filed on Sep. 18, 2019.
(60) Provisional application No. 63/048,469, filed on Jul. 6, 2020.

(51) Int. Cl. B22F 10/80; B33Y 50/00; B22F 12/90; G01B 11/06; G01B 11/24; G01B 11/30; G01N 9/02

(52) U.S. Cl. CPC B22F 10/80; B33Y 50/00; B22F 12/90; G01N 2009/024; G01B 11/24; G01B 11/303; G01N 9/02; G01B 11/0616

(57) ABSTRACT

A device for measuring powder bed density (PBD) (powder density for a layer) in additive manufacturing (AM) during operation. The device comprises means for determining a mass of the powder and means for determining a volume of the powder during spreading, thereby allowing determination of the powder bed density (powder density for the layer). The means for determining a volume of the powder comprises a laser assembly adapted to move a laser across a powder layer surface in both left and right directions for scanning. The device further allows for the determination of the layer surface profile as well as static and dynamic powder characteristics of the processes involved in the AM operation.

### CROSS REFERENCE TO RELATED APPLICATIONS

This application claims benefit of U.S. Provisional Patent Application No. 62/901,842, filed on Sep. 18, 2019 and U.S. Provisional Patent Application No. 63/048,469, filed on Jul. 6, 2020. The content of each of these two applications is incorporated herein in its entirety by reference.

### FIELD OF THE INVENTION

The present invention relates generally to 3D printing/additive manufacturing (AM) operations. More specifically, the invention relates to a device and method for measuring powder bed density (PBD) or powder density for each layer in such operations. The device and method of the invention also allows for the determination of the layer surface profile including layer roughness as well as static and dynamic powder characteristics of the processes involved in the operations including dynamic flow characteristics of the powder during spreading.

### BACKGROUND OF THE INVENTION

Additive manufacturing (AM) is a disrupting manufacturing technology with a growing popularity in numerous industries. According to ASTM F2792 [1], AM processes can be classified into seven categories; one of them is powder bed fusion (PBF), which is currently gaining most attention in the fabrication of metallic parts due to its high strength and dimensional accuracy. PBF-AM critically relies on the interaction between the energy source and the thin layers of powder that conform the powder bed. In order to ensure a reliable and high quality of the part being built, it is imperative to understand and quantify the properties of the metallic powder feedstock not only in its bulk state, but also as a thin (few 10 to 100 μm thickness) layer in an operating PBF machine. The layer density is directly proportional to the final part quality and inversely proportional to the part porosity [2-4].

For quantifying the powder bed density in AM, most approaches are using an estimate from measurement techniques traditionally used in powder metallurgy ruled by ASTM standards. Powder flowability is characterized according to ASTM B213 [5] and B964 [6] using either the Hall or Carney funnels. Apparent density is quantified according to ASTM B212 [7] using the Hall funnel. Tap density is measured according to ASTM B527 [8]. Finally, the determination of the static angle of repose is typically carried out following industry standard procedures. These techniques are only suitable for free-flowing powders and do not represent the actual dynamic powder flow conditions found in the additive manufacturing process. The applicability of these measured parameters on quantifying powder behavior inside a specific PBF machine under a given condition is thus limited [9]. Influence of the machine setup, e.g., re-coater arm geometry, speed, surface roughness, etc., on powder packing in the form of a thin layer is not considered.

Recently, state of the art technologies based on old methods, such as the shear test and the rotating drum technique [10-12], have found a niche of application in the additive manufacturing sector. These two techniques provide information on the dynamic bulk properties of the powders such as the resistance to flow and cohesion. Even though these two techniques are able to provide metrics of different powder batches for additive manufacturing, they are still not replicating the powder bed formation of the different additive manufacturing machines.

In 2015, an attempt to measure powder bed density was made by Van den Eynde et al. [13] using polymers as material feedstock. Powder layer density was calculated based on the weight of powders (weighted by a scale) spread with controlled speed and re-coater arm geometry on a known volume build plate, assuming the whole volume was occupied. A different approach was taken in 2016 by Jacob et al. [14] where closed powder trapping containers were designed based on the open container approach of Liu et al. [15]. The closed containers were placed in various x, y and z positions and built while a printing job was executed. An average powder bed density was then measured from the weight of trapped powder and volume of the containers.

The inventors are also aware of the following documents: GB 2564710 A, WO 2018/060033 A1, CN 109916771A, EP 09784751B1, CN 106984816B, U.S. Pat. No. 9,731,450 B2, CN 209666283 U, WO 2020/046212 A1, U.S. Pat. No. 1,0620,103 B2 and KR 101843493 B1.

The approaches where the powder bed density is measured in situ, possess some disadvantages. These disadvantages include the usage of large amounts of powder to carry out the test, the 3D printed container used to estimate density is not calibrated, additional post-processing is required to extract the samples, a new or a re-worked plate has to be used in every test, and also the cleaning of the printer make the overall process operationally expensive. In addition, after each test, the dynamic characteristics of the powder are not available.

There is a need for systems which allow for an efficient measurement of powder bed density in 3D printing/additive manufacturing operations. There is a need for such systems which also allow for the determination of other parameters during operation, and which are cost-effective.

### SUMMARY OF THE INVENTION

The inventors have designed and constructed a device for measuring powder bed density (PBD) or powder density for a layer in 3D printing/additive manufacturing (AM) operations. The device comprises means for determining a mass and a volume of the powder for a layer, thereby allowing determination of the powder bed density (powder density for the layer). The determination of the volume of the powder is performed during spreading. The means for determining the volume of the powder comprises a laser assembly adapted to move a laser across a powder layer surface in both left and right directions for scanning.

The powder bed density is determined for each layer during operation. This leads to the determination of cumulative density.

In embodiments of the invention, the device and associated method also allows for the determination of the layer surface profile, for example a layer roughness. Moreover, the device and associated method allows for the determination of static and dynamic powder characteristics of the processes involved in the operations, for example dynamic flow characteristics of the powder during spreading.

A computer including a suitable user interface is coupled to the device of the invention. This allows for a control of components of the device and for collection and analysis of the data generated.

Embodiments of the invention relate to a system for determining a mass of powder for each layer during operation in 3D printing/AM. Further embodiments relate to a system for determining a volume of power for each layer in 3D printing/AM operations; the determination of the volume is performed during spreading. Further embodiments relate to a system for determining a layer surface profile including layer roughness and/or visualizing static and dynamic powder characteristics of processes involved in the operations including dynamic flow characteristics of the powder during spreading.

The invention thus provides the following in accordance with aspects thereof:
(1) A device for measuring powder bed density (PBD) (powder density for a layer) in additive manufacturing (AM) during operation, the device comprising: means for determining a mass of the powder and means for determining a volume of the powder during spreading, thereby allowing determination of the powder bed density (powder density for the layer), wherein the means for determining a volume of the powder comprises a laser assembly adapted to move a laser across a powder layer surface in both left and right directions for scanning.
(2) The device according to (1), wherein the means for determining the mass of the powder comprises means for measuring a total mass of a system which includes a plate on which the powder is laid and other components of the system, and the mass of the powder is obtained by subtracting a mass of the plate and the other components from the total mass measured.
(3) The device according to (1) or (2), wherein the means for determining the volume of the powder comprises means for measuring a surface area occupied by the powder on a plate on which the powder is laid and means for measuring a thickness of the powder laid, thereby determining the volume of the powder.
(4) The device according to (3), wherein the thickness of the layer corresponds to a separation distance between the plate on which the powder is laid and another plate of device.
(5) The device according to any one of (1) to (4), wherein the laser allows for measurement of a surface area occupied by the powder on a plate on which the is laid.
(6) The device according to (4), wherein the surface area occupied by the powder corresponds to a surface of the plate on which the powder is laid.
(7) The device according to any one of (1) to (6), wherein the laser assembly is operatively attached to a means for recoating such that during operation, both components move together as one unit.
(8) The device according to any one of (1) to (6), wherein the laser assembly is operatively attached to a means for feeding the powder to the device and a means for recoating such that during operation, all three components move together as one unit.
(9) The device according to any one of (1) to (8), wherein the laser assembly allows for the determination of a layer surface profile, for example a layer roughness, a spreading profile.
(10) The device according to any one of (1) to (9), further comprising a camera placed on a side of the device, which allows for visualization of static and dynamic powder characteristics of processes involved in additive manufacturing such as dynamic flow characteristics of the powder during spreading.
(11) The device according to any one of (1) to (10), further comprising means for allowing any excess powder to be directed to and deposited on catcher plate.
(12) The device according to any one of (1) to (11), wherein the means for recoating comprises one or more of a recoater, a roller and a blade; and wherein, during operation, a user selects the recoater, the roller or the blade as desired.
(13) The device according to any one of (1) to (12), wherein a means for feeding the powder allows for a control of the feeding process, whereby the powder is fed only when necessary.
(14) The device according to any one of (1) to (13), wherein the laser assembly is further adapted to move up and down above the layer surface.
(15) The device according to any one of (1) to (14), further comprising a computer system coupled thereto, the computer system having a user interface and allowing for a control of components of the device and for collection of data generated.
(16) The device according to (15), which allows for determination of cumulative density from multiple consecutive layers.
(17) A device for use in additive manufacturing (AM), the device comprising: means for determining a mass of the powder for a layer; means for determining a volume of the powder for the layer during spreading; a laser assembly adapted to move a laser across the layer surface in both left and right directions, for scanning; and a computer system operatively coupled to the device, wherein, during operation, a powder bed density (PBD) (powder density for a layer) and a layer surface profile are determined, and data generated are collected and analyzed.
(18) A device for use in additive manufacturing (AM), the device comprising: means for determining a mass of the powder for a layer; means for determining a volume of the powder for the layer during spreading; a laser assembly adapted to move a laser across the layer surface in both left and right directions, for scanning; a camera placed on a side of the device; and a computer system operatively coupled to the device, wherein, during operation, a powder bed density (PBD) (powder density for a layer) and a layer surface profile are determined, static and dynamic powder characteristics of processes involved are visualized, and data generated are collected and analyzed.
(19) The device according to (17) or (18), which allows for determination of cumulative density from multiple consecutive layers.
(20) A system for measuring a mass of powder for a layer during operation in additive manufacturing (AM), the system comprising means for measuring a total mass of a system which includes a plate on which the powder is laid and other components of the system, and the mass of the powder is obtained by subtracting a mass of the plate and the other components from the total mass measured.
(21) A system for measuring a volume of power for a layer during operation, in additive manufacturing (AM), the system comprising: means for measuring, during spreading, a surface area occupied by the powder on a plate on which the powder is laid; and means for measuring a thickness of the powder layer, wherein the system comprises a laser assembly adapted to move a laser across a layer surface in both left and right directions for scanning.
(22)A system for determining a layer surface profile during operation, in additive manufacturing (AM), the system comprising a laser assembly adapted to move a laser across the layer surface in both left and right directions for scanning, during spreading.
(23) A system for determining a layer surface profile and visualizing static and dynamic powder characteristics of processes involved, during operation, in additive manufacturing (AM), the system comprising a laser assembly adapted to move a laser across the layer surface in both left and right directions for scanning, during spreading; and a camera placed on a side of system.

As will be understood by a skilled person, each of the features outlined above in (2) to (19) in relation to the device also apply to the system of the invention defined in each of (20) to (23) above.
(24) A method for measuring power bed density (PBD) (powder density for a layer) in additive manufacturing (AM), the method comprising using the device as defined in any one of (1) to (23).
(25) A method for measuring power bed density (PBD) (powder density for a layer) in additive manufacturing (AM), the method comprising using the system as defined in any one of (20) to (23).
(26) The method according to (24) or (25), wherein the device or system is placed in an airtight cage during use.
(27) The method according to (26), which is performed in an environment comprising inert gas such as argon, partial pressure, vacuum.
(28) A method for measuring power bed density (PBD) (powder density for a layer) in additive manufacturing (AM) during operation, the method comprising determining a mass of the powder and determining a volume of the powder during spreading, thereby allowing determination of the powder bed density (powder density for the layer), wherein determination of the volume of the powder during spreading comprises scanning a powder layer surface using a laser.
(29) A method for determining a layer surface profile in additive manufacturing (AM) during operation, the method comprising scanning a powder layer surface during spreading using a laser adapted to move a laser across the layer surface in both left and right directions for scanning.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the appended drawings:

FIG. 1: Feeder assembly.

FIG. 2: Elevator assembly (top plate lifting assembly).

FIG. 3: Adapter assembly.

FIG. 4: Load cell (with adapter bolted and surrounded by the elevator assembly).

FIG. 5: Main plate assembly and cage (5A). Main Plate (5B)

FIG. 6: Drive system.

FIG. 7: Tension system.

FIG. 8: Laser assembly.

FIG. 9: Apparent densities obtained with the Ti₆Al₄V powder with a 50 μm layer thickness.

FIG. 10: Apparent densities obtained with the Ti₆Al₄V powder with a 100 μm layer thickness.

FIG. 11: Apparent densities obtained with the IN718 powder with a 50 μm layer thickness.

FIG. 12: Apparent densities obtained with the IN718 powder with a 100 μm layer thickness.

### DESCRIPTION OF ILLUSTRATIVE EMBODIMENTS

Before the present invention is further described, it is to be understood that the invention is not limited to the particular embodiments described below, as variations of these embodiments may be made and still fall within the scope of the appended claims. It is also to be understood that the terminology employed is for the purpose of describing particular embodiments; and is not intended to be limiting. Instead, the scope of the present invention will be established by the appended claims.

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this disclosure pertains.

Use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used herein when referring to numerical values or percentages, the term “about” includes variations due to the methods used to determine the values or percentages, statistical variance and human error. Moreover, each numerical parameter in this application should at least be construed in light of the number of reported significant digits and by applying ordinary rounding techniques.

The terms “3D printing” and “additive manufacturing (AM)” are used interchangeably throughout the text and refer to such operations as will be understood by a skilled person and to which the device or machine according to the invention are applied.

The terms “device” and “machine” are used interchangeably throughout the text and refer to the device or machine according to the invention.

As used herein, the term “power bed density (PBD)” refers to the power density for a layer in additive manufacturing (AM).

The inventors have designed and constructed a device for measuring powder bed density (PBD) or powder density for a layer during operation in 3D printing/additive manufacturing (AM). The powder bed density is determined for each layer during operation, which leads to the determination of cumulative density. The quality of the powder at each layer is thus monitored.

The device also allows for the determination of the layer surface profile, for example a layer roughness. The device further allows for the determination of static and dynamic powder characteristics of the processes involved in the AM operation, for example dynamic flow characteristics of the powder during spreading

An embodiment of the device according to the invention comprises at least the following components: a feeder assembly, an elevator assembly, an adapter assembly, a load cell, a main plate assembly, a leveling mechanism, a drive system, a tension system, a recoater/roller/blade, a test bench, a frame, a laser assembly. Each of these components of the device will be described in detail below making reference to the associate method and also to the accompanying figures.

An embodiment of the method of the invention proceeds as follows:

Step 1—Powder is deposited on the main plate from the feeder assembly. A welded silo holds the powder, and in due time a dosing mechanism allows the powder to fall from the silo onto a working surface.

Step 2—When the feeder assembly, along with the laser assembly and the recoater/roller/blade moves towards a trigger, the trigger pushes a slider in and out, which opens the feeder and allows the powder to fall onto the main plate.

Step 3—A center plate is positioned slightly lower than the main plate, depending on the desired layer thickness. For example, if the desired layer thickness is 20 μm, the center plate is positioned 20 μm below the main plate surface.

Step 4—A recoater, roller or blade spreads the powder deposited onto a working surface over the center plate (the 100x100 mm plate) located near the center of the machine.

Step 5—Any excess powder ends up in a powder catcher, to avoid any components being damaged by the powder.

Step 6—The center plate is lowered onto the load cell by the elevator assembly. The total mass of the center plate, powder and associated adapters is measured; and the mass of the powder is determined by subtracting the mass of the center plate and adapters. The volume of the powder is determined based on the surface area of the center plate occupied by the powder and the thickness of the layer. In embodiments of the invention, the surface area of the center plate occupied by the powder may correspond to the surface of the center plate. In other embodiments of the invention, the surface area occupied by the powder may be different from the surface of the center plate. The laser is used in the determination of the exact surface area occupied by the powder. The laser is also be used in the determination of the thickness. From the mass and volume of the powder determined, powder density for the layer is calculated.

Step 7—The powder on the center plate is scanned with the laser to analyze the profile of the powder surface (layer surface profile). As will be understood by a skilled person, the layer surface profile includes various parameters such as roughness, profile of the spreading, etc.

Steps 2 to 7 are repeated for each layer.

The following is a description of embodiments of components of the device according to the invention and further details and embodiments on the above method Steps 2-7 are provided.

### Feeder Assembly

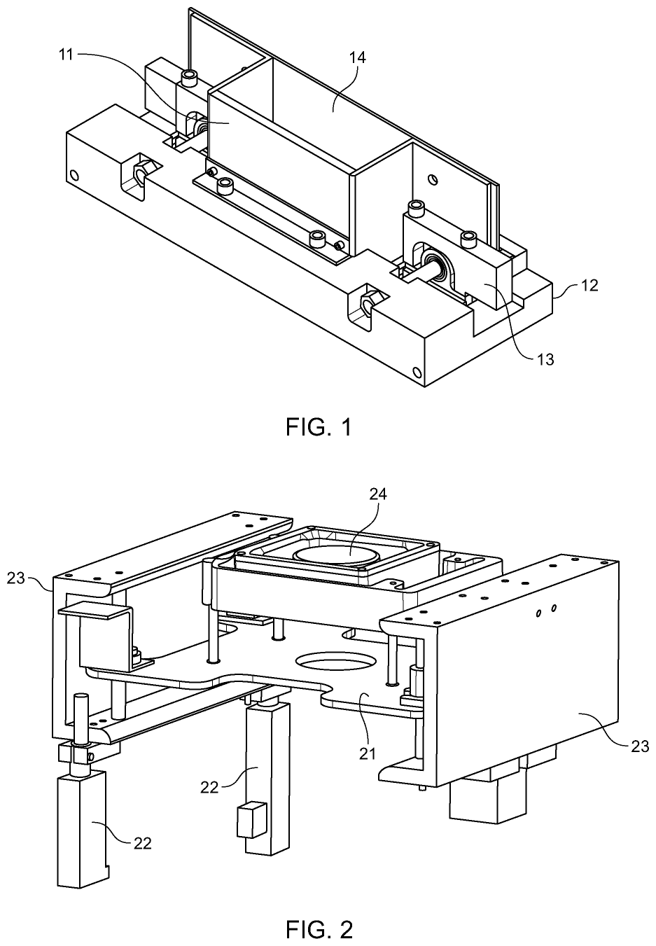

The feeder assembly is illustrated in FIG. 1. It holds the powder, and when needed, drops the powder onto the main plate, so that the powder can be spread thereon. The feeder assembly comprises three sub-assemblies, namely, a welded silo 11, a dosing mechanism 12, and a slider assembly 13.

The welded silo 11 holds the powder. There is a slot at the bottom of the silo for the powder to fall through and exit the silo. The plates including a front plate 14 are made of aluminum and are welded together. As will be understood by a skilled person, the plates may be made of any other suitable materials. The dosing mechanism acts like a valve that lets the powder exit the silo.

The dosing system 12 consists of a cage which holds all the components of the feeder assembly. Inside the cage is a top plate and a bottom plate made of steel, two polytetrafluoroethylene (PTFE) gaskets which allow the slider base to move back and forth (in the recoating direction) smoothly. As will be understood by a skilled person, components of the dosing system may be made of any other suitable material.

The slider assembly 13 comprises a plate which slides back and forth and allows the powder to fall from the silo only when needed. The slider assembly is supported by the dosing system via a bearing mounted on a connecting rod. The connecting rod has a spring around it, so that, when the spring is compressed (by the trigger), the slider moves into the cage and the powder falls onto a bottom plate. Then, as the spring expands, the powder is pushed towards the slot on the bottom plate. Once the powder reaches the slot, the powder falls onto the main plate.

The feeder assembly moves with a system comprising a recoater and/or a roller and/or a blade (recoater/roller/blade) as well as the laser assembly. In embodiments of the invention, the feeder assembly may be removed from the front of the machine by unscrewing two bolts.

### Elevator Assembly (Top Plate Lifting Assembly)

The elevator assembly is illustrated in FIG. 2. It controls the height of the center plate which is supported by the square plate 24. More specifically, it moves the center plate downwards onto the load cell, moves the center plate upwards to the main plate, and neatly stores any excess of powder that falls from parts of the machine such as from the load cell. The elevator assembly comprises at least the following components: an elevator 21, four spacers, a cage left and a cage right 23, a powder catcher, a square plate, linear shafts and linear bearings, a stepper motor, a lead screw and a nut. Two linear gauges 22 measure the changes in height of the elevator 21. The linear gauges read off the contact adapters and are mounted to the cage right 23.

The elevator assembly moves the elevator, powder catcher and square plate 24 which supports the center plate, up and down. When the powder is laid onto the center plate, the elevator which is driven by the motor, moves down until the center plate contacts the load cell. Then, the elevator moves downwards slightly more, so that the load cell can measure the mass of the powder, center plate and adapters. From there, the elevator moves back up, bringing the center plate towards the main plate. The process repeats itself for each layer.

When the user wants to clean up the machine or remove the powder catcher, the user first removes a removable plate. The Elevator moves all the way up, to the point where the powder catcher and square plate are above the surface of the main plate. The user can then unscrew four bolts and detach the powder catcher, square plate and standoffs from the elevator, and the powder catcher can be cleaned up easily.

The elevator comprises a plate which holds the powder catcher, the square plate and the center plate, except when the center plate is being weighed. The elevator is driven up and down by a motor/lead screw/nut system. A C-channel holds the linear rods together. The C-channel bolts onto the bottom surface of the main plate and holds the motor. The C-channel also holds the linear gauges and their mounts.

The powder catcher has slots that store any powders that drops. The powder catcher can be removed along with the square plates for the user to clean. The square plate is bolted onto the powder catcher. The square plate comprises an angled inner slot which supports the center plate. Grooves are provided on the inner edges of the square plate so that powder can fall into the powder catcher.

The linear shafts allow the elevator to go up and down smoothly. The linear bearings on the linear shafts are self-aligning, so that the elevator does not seize from eccentric loading. A stepper motor, a lead screw and a nut convert the motor's rotational motion into a translational motion. The two linear gauges measure the distance traveled by the elevator accurately. They are pointed to the contact adapters and supported on the cage right. In embodiments of the invention, the elevator assembly is adapted to receive various types of load cell.

### Adapter Assembly

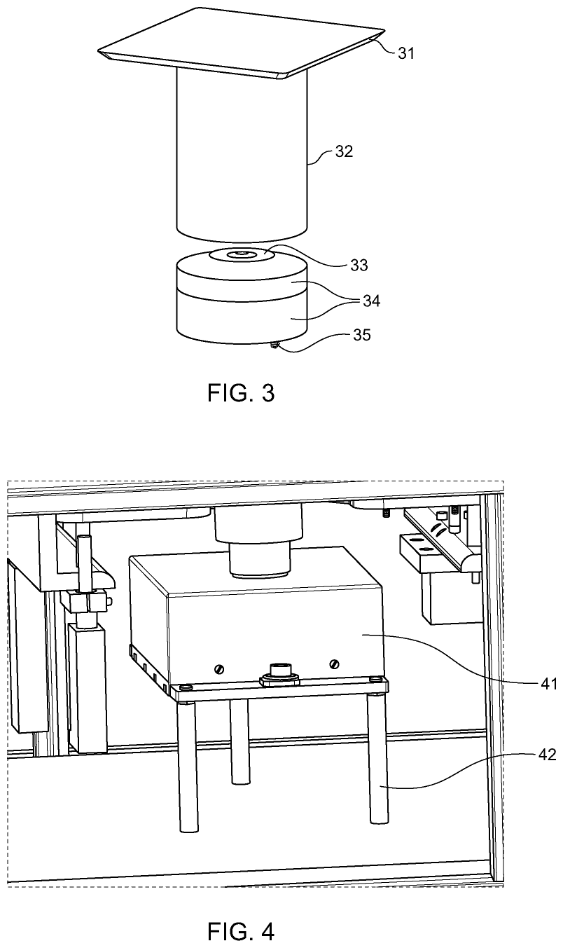

The adapter assembly is illustrated in FIG. 3. It supports the center plate 31, and acts as a coupler to the load cell. The adapter assembly comprises at least the following components: the center plate 31, a female adapter 32, at least two male adapters 34, along with bolts 35 and a cap 33. Before the load cell is coupled to the center plate (via male and female adapters), the male and female adapters are separated. Then, when the elevator is lowered, the male adapter contacts the female adapter. The elevator lowers slightly more so that only the adapters, center plate and powder are on the load cell. It is at this moment that the load cell can measure the mass of the center plate, powder and adapters. In embodiments of the invention, the components are designed to be as lightweight as possible taking into consideration the load limits of the load cell. For example, male and female adapters may be machined from a material such as plastic.

The powder on the center plate 31 has its mass and volume determined, and thus the density is calculated. The center plate is bolted onto the female adapter from underneath. The bottom surface of the center plate is concave. This is because when the center plate is lowered onto the male adapter which has a concave surface, the center plate is self-leveled with the male adapter, whose corresponding surface is convex. The male adapter consists of two parts. A bottom male adapter which is bolted onto the load cell. And a top male adapter which is bolted onto the bottom male adapter.

### Load Cell System

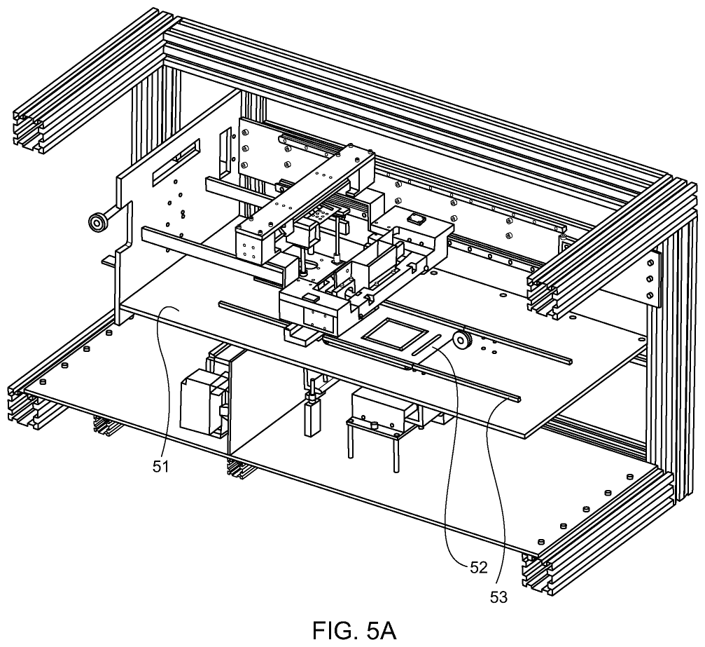

The load cell system is illustrated in FIG. 4. It measures the total mass of the center plate, powder and adapter, which ultimately leads to the determination of the mass of the powder on the center plate. When the center plate is lowered onto the load cell 41, the load cell reads the mass of the adapter assembly, center plate and powder. The mass of the powder can be determined by subtracting the mass of the center plate and adapters from the mass read by the load cell. The load cell is supported by spacers 42 and a bolt. The load cell is attached to the frame of the cage.

### Main Plate Assembly

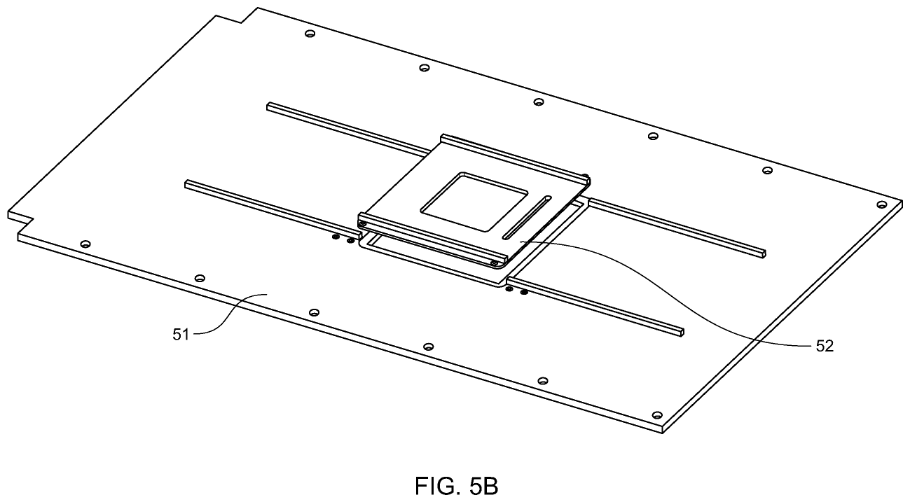

The main plate assembly is illustrated in FIG. 5A. The main plate 51 further illustrated in FIG. 5B. The main plate assembly provides a partition between top and bottom areas of the machine as well as a surface for the recoated/roller/blade to spread the powder. The main plate 51 comprises at least the following components: a removable plate 52 and six anodized barriers 53. The main plate is fixed and prevents the removable plate from going lower. The anodized barriers keep the powder contained in a closed area around the center plate. Thus, preventing the powder from going to the corners of the machine, where cleaning can be more difficult. Two sets of anodized barriers are bolted on the main plate, while one set is bolted on the removable plate. The removable plate, located inside the main plate, surrounds the square plate (in the elevator assembly). The removable plate remains at the same level as the main plate, except when cleaning, where the powder catcher and square plate push the removable plate above the main plate. The removable plate also has an overflow slot. This is so that any excess powder can be dropped into that slot, so that the main plate remains clean. Any excess powder will end up in the powder catcher. During most of the operation, the removable plate remains attached to the main plate. However, when cleaning is necessary, the removable plate is unscrewed from the main plate, and the elevator pushes the removable plate upwards. From there, the user can remove the removable plate to unscrew the four bolts needed to remove the powder catcher.

### Leveling Mechanism

The leveling mechanism allows for fine-tuning the height of the recoater/roller/blade manually. In embodiments of the invention, this is performed by a designated user such that a regular user does not need to do it. The leveling mechanism comprises at least the following components: a leveling bar, two linear bearing mounts, two steel shafts, two nuts, two dials and two threaded rods. The leveling mechanism allows for fine-tuning the height of the recoater/roller/blade by turning two dials, located at the two ends of the leveling bar. By turning the dial, the thread moves up and down. The designated user may adjust the height, then lock it with the nut underneath the linear bearing mount. The nut and the dial act as clamps on the linear bearing mount, thereby locking the position of the leveling bar. The leveling bar is attached to the threaded rod and moves up and down on each end when the dial is turned. The leveling bar also holds the recoater/roller/blade. The linear bearing mount supports the dial, the threaded rod and the linear rods. The nuts are tightened against their surfaces to lock the threaded rod and prevent it from moving. This part will also support the clamps for a timing belt. It also bolts onto the feeder and the laser assemblies. The steel shafts ensure that the leveling bar is stable when locked, and when being adjusted. The threaded rod allows for fine adjustment of the height of the leveling bar. The threaded rod threads into the leveling bar and the dial and nut lock its position. The nuts lock the leveling mechanism and constrain it. The dials are used to adjust the height of the threaded rod manually, and thus the leveling bar and recoater/roller/blade. Before operating the machine, the recoater/roller/blade must have its surface evenly distributed onto the main plate. The leveling bar has its height fine-tuned, and then locked. In embodiments of the invention, the leveling bar is L-shaped.

### Drive System

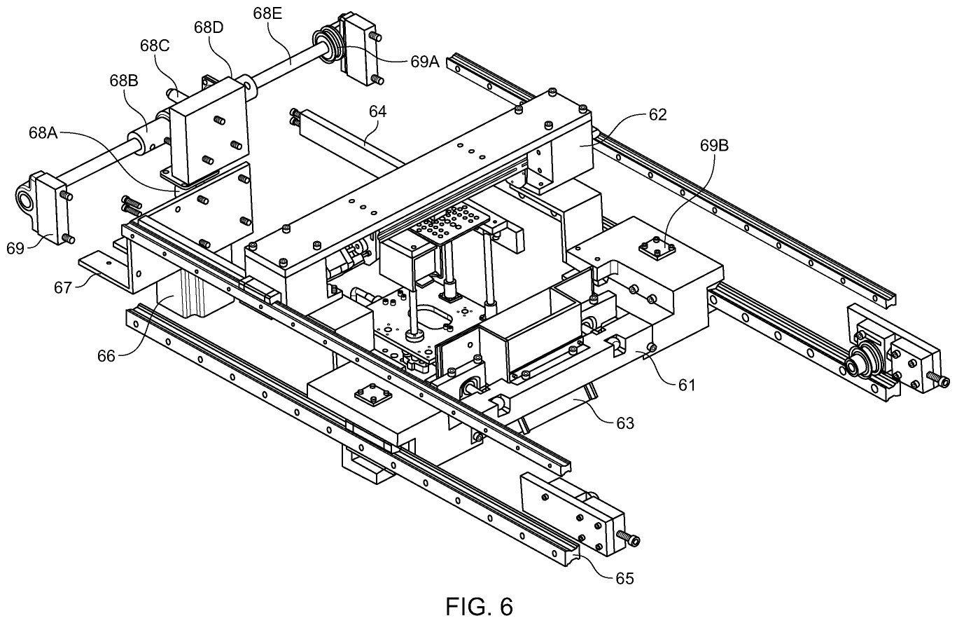

The drive system is illustrated in FIG. 6. It moves the recoater/roller/blade, the feeder assembly 61, and the laser assembly 62 back and forth, in the recoating direction. When the feeder assembly approaches the trigger 64, it pushes against the trigger, which pushes the slider and opens the feeder assembly 61 to allow the powder to fall. The powder falls just between the removable plate and the recoater/roller/blade. A recoater 63 is illustrated. The drive system comprises at least the following components: a motor, a machinable coupler 68A, a gearbox 68, shafts 68E, couplers 68B, a shim 69, a gearbox shim 68, left and right L-shaped bracket pulleys 69A, a timing belt, a belt clamp 69B, a linear rail and linear carriage 65, a stepper motor 66, a motor mount 67 and the trigger 64.

The gearbox splits the motion into two shafts. The gearbox shim supports the gearbox. The gearbox shim is attached to a vertical wall of the machine. The shafts are attached to the output shafts of the gearbox via a pair of couplers. The shafts are partially a D-profile. The pulleys are attached to the shafts. The pulleys 69 transmit motion from the stepper motor 66 (via the gearbox) to the feeder assembly 61, the laser assembly 62 and the recoater/roller/blade. A timing belt is provided on either side of the machine. The trigger 64, bolted to the vertical wall, pushes the bearing housing (slider assembly). This allows the powder to fall onto the bottom plate. Then, once the trigger is being released, the powder falls from the bottom plate, onto the main plate. Both the right L-shaped bracket and the left L-shaped bracket on the opposing side connect the linear bearing mount to the laser assembly. The belt clamp 69B holds a section of the timing belt to the linear bearing mounts from the leveling mechanism.

The linear rail and linear carriage allow the linear bearing mount to move smoothly. The stepper motor 66 drives the laser assembly 62, feeder assembly 61, recoater/roller/blade via the pulleys 69A and timing belt. The motor mount 67 holds and accommodates the motor. In embodiments of the invention, the motor is a NEMA 23 and NEMA 34 motor. This allows for adjustability when selecting motors to drive the feeder, recoater/roller/blade and laser assembly. A machinable coupler bolts to the motor's shaft to the input shaft of the gearbox. The shim allows the shafts to be supported by bearings. The bearings are attached to the vertical wall of the machine. As will be understood by a skilled person, the recoater/blade/roller, along with the feeder assembly and laser assembly move from front to back all as one unit. In embodiments of the invention, motors may be attached directly to the pulleys.

### Tension System

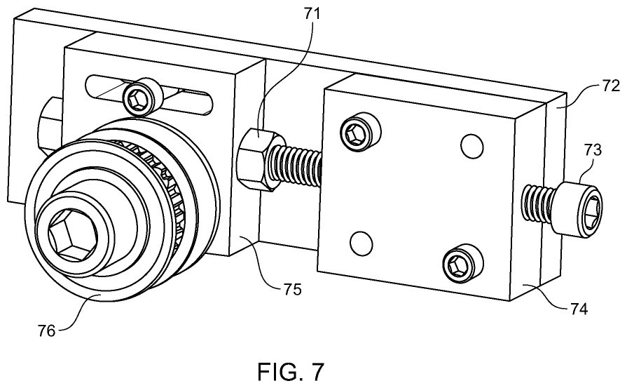

The tension system is illustrated in FIG. 7. It keeps the belt under tension, throughout the lifetime of the belt. The belt tension may be adjusted whenever necessary by adjusting the center distance of the pulleys. The tension system comprises at least the following components: a mobile tension block 75, a fixed tension block 74 and an intermediate block 72. Other components include an adjustment bolt 73 and an adjustment nut 71. Each mobile tension block holds a pulley 76 and its position in the recoating direction may be adjusted by turning the adjustment bolt with an Allen key. When brought further from the front of the machine, the belt tension lowers, and when brought closer to the front of the machine, the belt tightens. The mobile tension block comprises a slot, so that the user may secure the position of the mobile tension block to the intermediate block with a bolt. The user may also tighten both nuts to ensure the position of the pulley is fixed. The fixed tension block holds the bolt that is used to adjust the position of the mobile tension block. The intermediate block supports the mobile tension block and the fixed tension block.

### Recoater/Roller/Blade

The recoater, roller or blade spreads the powder which exits the silo, over the center plate. The spreading must be as evenly distributed and consistent as possible. The user has the choice of either using the recoater, the roller or the blade. All three components are removably mounted on the leveling bar (leveling mechanism). The recoater comprises two plates, and a rubber cylinder is provided between the two plates. The rubber cylinder is not allowed to move in any direction. The rubber cylinder recoats. There is also a ramp above the recoater. The blade is similar to the recoater, except that the rubber cylinder and the recoater head are replaced with a blade. The roller also spreads the powder. The cylindrical drum of the roller rotates and is powered by a motor. As will be understood by a skilled person, the roller may comprise other components. The recoater, blade and roller are easily serviceable since they are each removably mounted to the leveling bar with bolts facing the front of the machine. The recoater, roller and blade each have a ramp to let the powder fall from the silo. The ramp is angled from the vertical axis to mimic a Hall funnel. In embodiments of the invention, the ramp is angled from the vertical axis by about 30 degrees.

### Laser Assembly

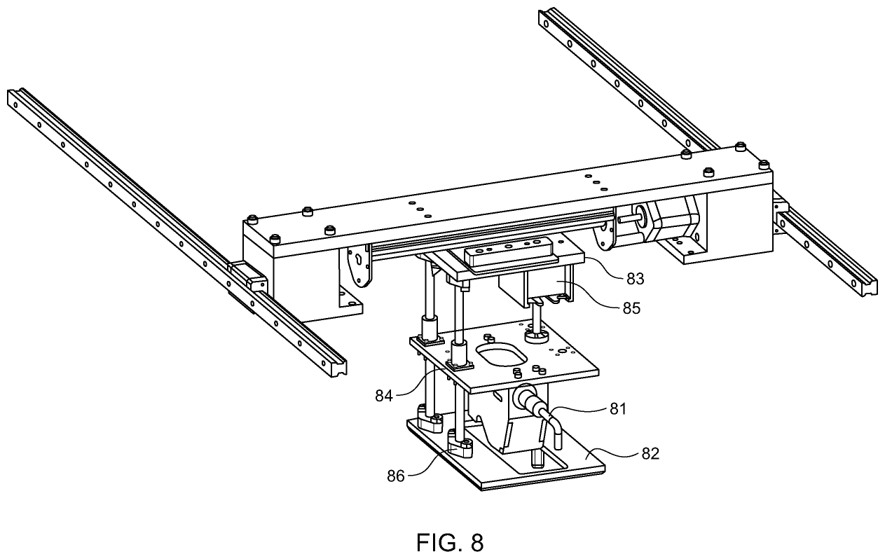

The laser assembly can be seen in FIG. 8. It comprises a laser 81 which scans the surface of the powder and determines the profile of the powder layer (layer surface profile). As will be understood by a skilled person, the layer surface profile includes various parameters such as roughness, profile of the spreading, etc. In embodiments of the invention, the laser is used in the determination of the surface area occupied by the powder on the center plate. The laser is also be used in the determination of the thickness of a layer.

The laser assembly moves the laser across the center plate, from left to right and vice versa, and up and down. The laser needs to move upwards while recoating, to prevent powder from meeting the laser. The laser needs to move downwards to scan the powder surface at its focal point.

Other components of the laser assembly include a linear actuator, linear shafts, bearings, clamps 86, a top plate 83, a lower plate 82 and an elevator 84 (independent from the elevator assembly described above). Moreover, the laser assembly comprises a motor 85, a lead screw and a nut, to move in the vertical direction. In embodiments of the invention, the laser is 2D profiler. The linear actuator allows the laser to move from left to right and vice versa. The laser moves from front to back with the motor used in the drive system (the motor that moves the laser assembly, feeder assembly, and recoater/roller/blade). The linear shafts, bearings and clamps move the laser up and down, while being supported and rigid. The top plate bolts onto the linear actuator and the linear shafts. In embodiments of the invention, the top plate is oriented at 0 degree or 90 degrees. The lower plate acts as a limit to the most bottom position of the laser. It also prevents the laser from hitting any components of the system. The elevator bolts onto the laser and allows the laser to move up and down smoothly. The motor/lead screw/nut powers allow the laser (and the elevator) to move up and down.

### Camera

The camera is for determining the layer surface profile. In embodiments of the invention, the camera is aligned with the recoater. As will be understood by a skilled person the layer surface profile includes parameters such as roughness, spreading profile, etc. In embodiments of the invention, both a laser and a camera are used in this regard. The camera also allows for the visualization of dynamic flow characteristics of the powder during spreading. Indeed, the camera tracks the powder movement during recoating. Images are captured. It is possible to see the flowing angle of the powder when it is pushed forward by the recoater. An automated image collection and image analysis is developed.

### Cage (Test Bench, Frame)

The cage, test bench or frame is to be able to constrain the components of the machine for testing. A part of the cage can be seen in FIG. 5A. The cage may be an enclosure with the frame made of aluminum extrusions. It may also comprise several aluminum panels to support the various components of the machine. The panels of the cage embody components of the machine such as the vertical wall, the rail plates, the powder plate and the bottom plate. A vertical wall of the frame bolts the trigger, the gearbox shim, the shims and the motor mount. The cutouts are for cables and the timing belts. The rail plates support the linear rails and the tension mechanism. The powder plate provides a partition between any powder that may leak, and the electrical components such as drivers and controllers. The bottom plate supports the load cell.

The cage is rigid and supports all the components of the device. In embodiments of the invention, the cage further supports exterior panels. In other embodiments, the cage comprises an airtight seal. This allows for the operations to be conducted in desired environment such inert gas, partial pressure, vacuum. In other embodiments of the invention, the cage is built with aluminum extrusions.

In embodiments of the invention, the cage has doors on the front and/or the sides. The doors allow the user to perform several tasks, including removing the powder catcher, the recoater/roller/blade and/or the feeder for cleaning, and checking on the electronics which are located at the rear of the machine.

### Computer

A computer is used in association of the device and method of the invention. A suitable user interface is provided. The computer allows for the control of movement of all components of the device and collects data accordingly.

Powder Characterization of IN718 and Ti₆Al₄V Powders

Two powders were selected for bench-mark density measurements: IN718 and Ti₆Al₄V Each powder was fully characterized in house according to ASTM B212 and B213; results are summarized in Table 1 below. Three repeats were carried for each powder at 24° C. and a humidity of 40%. As shown in Table 1, each powder has a D₅₀ of about 35 μm, which concords with the information provided by the manufacturer. For the IN718 powder, the Hall flow is 16.09 s/50 g; however, the Ti₆Al₄V powder did not flow under the testing conditions. The apparent densities measured with the Hall flowmeter are 4.36 g/cm³ for In718 and 2.19 g/cm³ for Ti₆Al₄V; with the Carney flowmeter, they are 4.36 g/cm³ and 2.21 g/cm³, respectively, which is virtually the same.

TABLE 1
Characterization of In718 and Ti₆Al₄V powders

| | | | Apparent | Apparent |
|---|---|---|---|---|
| | Powder size | | density | density |
| | distribution | Hall flow | (g/cm³) | (g/cm³) |
| Powder | (D₅₀, μm) | (s/50 g) | Hall funnel | Carney funnel |
| IN718 | 33 | 16.09 ± 0.09 | 4.36 ± 0.04 | 4.36 ± 0.04 |
| Ti₆Al₄V | 34 | No flow | 2.19 ± 0.02 | 2.21 ± 0.02 |

Density Measurements of IN718 and Ti₆Al₄V Powders

For the density measurements, the rubber re-coater was used with a recoating speed of 2500 mm/min. Measurements were carried with an average temperature of 24° C. and a humidity of 40%. No ionization blower was employed. For each combination of powder and layer thickness, 5 repeats of 20 layers (or the maximum possible number of layers without damaging the load cells) were performed. Average densities are summarized in Tables 2-4 below.

For the IN718 powder (Table 2), the average layer apparent densities are 4.42±0.35 and 4.86±0.19 g/cm³ for the 50 and 100 μm layer thicknesses, respectively. The average apparent density measured for the 50 μm layer is thus statistically identical to the one (4.36±0.04 g/cm³; Table 1) measured with the Hall flowmeter. However, the average apparent density measured for the 100 μm layer is 10% higher.

For the Ti₆Al₄V powder (Table 3), the average apparent densities are 2.01±0.06 and 2.40±0.06 g/cm³ for the 50 and 100 μm layer thicknesses, respectively. Both values are thus within 10% of the density (2.19±0.02 g/cm³; Table 1) measured with the Hall flowmeter.

For both, the IN718 and Ti₆Al₄V powders, the cumulative apparent densities (Table 4) are either statistically identical to the ones measured with the Hall flowmeter (Table 1) or 10% higher. In addition, the apparent densities measured for the 100 μm layer are systematically larger than the ones measured for the 50 μm layer. This difference is due to the dynamics of the powder: the thickness/powder diameter (delta/D) ratio has increased.

TABLE 2
Average layer apparent densities in g/cm³ measured from five repeats
and two different layer thicknesses using IN718 powder

| Thickness | Test 1 | Test 2 | Test 3 | Test 4 | Test 5 | Average |
|---|---|---|---|---|---|---|
| 50 μm | 3.86 ± 1.69 | 4.57 ± 1.30 | 4.79 ± 1.18 | 4.39 ± 1.48 | 4.48 ± 1.26 | 4.42 ± 0.35 |
| 100 μm | 4.66 ± 1.67 | 4.65 ± 0.84 | 5.03 ± 0.81 | 4.89 ± 0.81 | 5.05 ± 0.73 | 4.86 ± 0.19 |

TABLE 3
Average layer apparent densities in g/cm³ measured from five repeats
and two different layer thicknesses using Ti₆Al₄V powder

| Thickness | Test 1 | Test 2 | Test 3 | Test 4 | Test 5 | Average |
|---|---|---|---|---|---|---|
| 50 μm | 2.00 ± 0.71 | 1.93 ± 0.87 | 2.02 ± 0.79 | 2.09 ± 0.71 | 2.02 ± 0.84 | 2.01 ± 0.06 |
| 100 μm | 2.47 ± 0.46 | 2.46 ± 0.38 | 2.39 ± 0.58 | 2.35 ± 0.65 | 2.33 ± 0.63 | 2.40 ± 0.06 |

TABLE 4
Average layer apparent density and cumulative density
for each powder and layer thickness combination

| | IN718 | | Ti₆Al₄V | |
|---|---|---|---|---|
| | Apparent | Cumulative | Apparent | Cumulative |
| Layer | density | density | density | density |
| thickness | (g/cm³) | (g/cm³) | (g/cm³) | (g/cm³) |
| 50 μm | 4.42 ± 0.35 | 4.71 ± 0.15 | 2.01 ± 0.06 | 2.21 ± 0.04 |
| 100 μm | 4.86 ± 0.19 | 4.87 ± 0.30 | 2.40 ± 0.06 | 2.48 ± 0.04 |

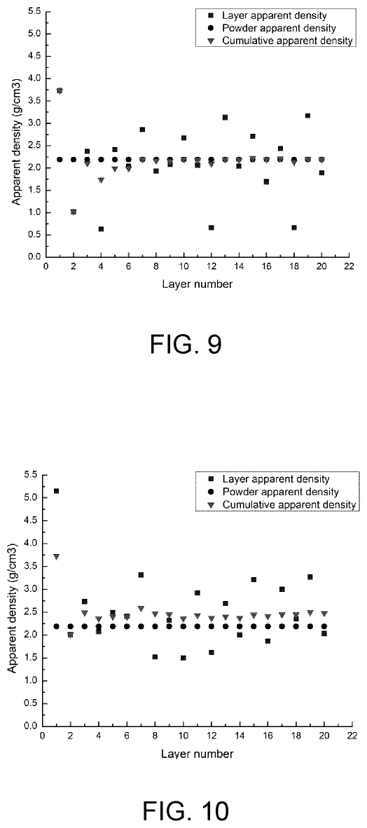

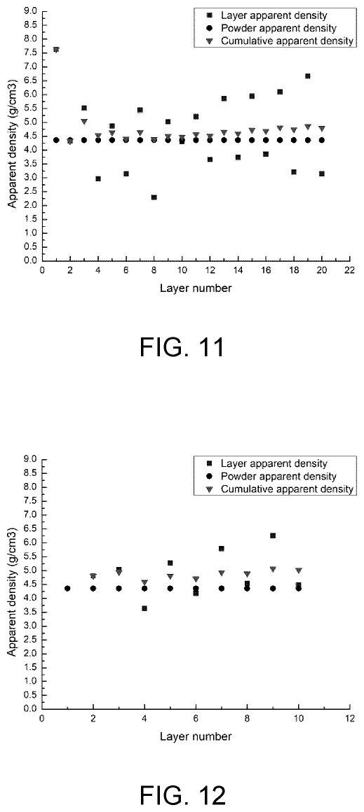

Typical test results, for each of the four combination of powder and layer thickness (IN718 and Ti₆Al₄V powders with 50 and 100 μm layer thicknesses) listed in Tables 3-4 are shown in Tables 5-8 below and depicted in FIGS. 9-12, respectively. Two general trends are observed.

First, the apparent density measured for the layer 1 (the values are highlighted in Tables 5-8) is always significantly higher than the ones obtained for the following layers. These unusual high densities may be due to the loose packing of the base coat (or layer 0), which consists of a layer of 200 μm of powder coated directly to the top plate. The reason for this loose packing is likely related to the surface roughness of the top plate: it did not generate sufficient friction to retain enough powder and as a result, too much powder fell through the gap between the top plate and the center plate, which results in a poorly packed base coat. When the layer 1 is subsequently spread, the added powder densifies the base coat (layer 0) and the extra space created is filled with powder that is not considered in the measurement of the volume. As a result, the volume of layer 1 is underestimated, which leads to a much higher calculated density. For this reason, the apparent densities calculated for the layers 1 were always excluded.

Second, an oscillation is observed in the layer apparent densities as more layers are added. However, the cumulative apparent densities remain close to the powder apparent density. A possible reason for this is the packing density variation caused by the difference in powder size distribution (PSD) from one layer to another. This PSD variation may be determined when a laser with a better resolution to measure the roughness profile of the powder surface is used. Another possible reason is the downward pushing force applied by the recoater during the recoating process: it densifies the existing layer while a new layer is added, leading to a higher apparent density. Powders are thus loosely packed on a dense bed. This is part of the natural dynamic behavior of powders.

TABLE 5
Typical results obtained with the
Ti₆Al₄V powder at 50 μm layer thickness

| Layer | Volume | Weight | Apparent density | Cumulative density |
|---|---|---|---|---|
| number | (cm³) | (g) | (g/cm³) | (g/cm³) |
| 1 | 0.82 | 3.06 | 3.73 | 3.73 |
| 2 | 0.26 | 0.26 | 1.02 | 1.02 |
| 3 | 1.02 | 2.43 | 2.37 | 2.10 |
| 4 | 0.42 | 0.26 | 0.63 | 1.74 |
| 5 | 1.01 | 2.43 | 2.41 | 1.99 |
| 6 | 0.32 | 0.65 | 2.04 | 1.99 |
| 7 | 0.89 | 2.55 | 2.86 | 2.19 |
| 8 | 0.53 | 1.03 | 1.93 | 2.16 |
| 9 | 0.92 | 1.92 | 2.08 | 2.15 |
| 10 | 0.58 | 1.54 | 2.67 | 2.20 |
| 11 | 0.81 | 1.66 | 2.06 | 2.18 |
| 12 | 0.40 | 0.26 | 0.66 | 2.09 |
| 13 | 0.73 | 2.30 | 3.13 | 2.19 |
| 14 | 0.88 | 1.79 | 2.04 | 2.18 |
| 15 | 0.85 | 2.30 | 2.71 | 2.22 |
| 16 | 0.53 | 0.90 | 1.69 | 2.19 |
| 17 | 0.89 | 2.17 | 2.43 | 2.21 |
| 18 | 0.59 | 0.39 | 0.66 | 2.13 |
| 19 | 0.81 | 2.55 | 3.17 | 2.20 |
| 20 | 0.48 | 0.90 | 1.89 | 2.19 |

TABLE 6
Typical results obtained with the
Ti₆Al₄V powder at 100 μm layer thickness

| Layer | Volume | Weight | Apparent density | Cumulative density |
|---|---|---|---|---|
| number | (cm³) | (g) | (g/cm³) | (g/cm³) |
| 1 | 0.45 | 2.30 | 5.15 | 3.73 |
| 2 | 0.89 | 1.79 | 2.01 | 2.01 |
| 3 | 1.77 | 4.84 | 2.73 | 2.49 |
| 4 | 1.17 | 2.43 | 2.08 | 2.36 |
| 5 | 1.74 | 4.33 | 2.49 | 2.40 |
| 6 | 1.17 | 2.81 | 2.41 | 2.40 |
| 7 | 1.77 | 5.86 | 3.31 | 2.59 |
| 8 | 1.09 | 1.66 | 1.52 | 2.47 |
| 9 | 1.76 | 4.08 | 2.32 | 2.45 |
| 10 | 1.11 | 1.66 | 1.50 | 2.36 |
| 11 | 1.70 | 4.97 | 2.92 | 2.43 |
| 12 | 1.18 | 1.92 | 1.62 | 2.37 |
| 13 | 1.66 | 4.46 | 2.69 | 2.40 |
| 14 | 1.15 | 2.30 | 2.00 | 2.37 |
| 15 | 1.63 | 5.22 | 3.21 | 2.44 |
| 16 | 1.30 | 2.43 | 1.87 | 2.41 |
| 17 | 1.66 | 4.97 | 3.00 | 2.45 |
| 18 | 1.20 | 2.81 | 2.35 | 2.45 |
| 19 | 1.60 | 5.22 | 3.27 | 2.50 |
| 20 | 1.20 | 2.43 | 2.03 | 2.48 |

TABLE 7
Typical results obtained with IN718
powder at 50 μm layer thickness

| Layer | Volume | Weight | Apparent density | Cumulative density |
|---|---|---|---|---|
| number | (cm³) | (g) | (g/cm³) | (g/cm³) |
| 1 | 0.73 | 5.60 | 7.63 | 7.63 |
| 2 | 0.56 | 2.43 | 4.32 | 4.32 |
| 3 | 0.88 | 4.84 | 5.51 | 5.05 |
| 4 | 0.48 | 1.41 | 2.96 | 4.53 |
| 5 | 0.86 | 4.21 | 4.87 | 4.63 |
| 6 | 0.49 | 1.54 | 3.14 | 4.41 |
| 7 | 0.94 | 5.10 | 5.44 | 4.64 |
| 8 | 0.50 | 1.15 | 2.29 | 4.39 |
| 9 | 0.96 | 4.84 | 5.02 | 4.50 |
| 10 | 0.50 | 2.17 | 4.31 | 4.48 |
| 11 | 0.91 | 4.71 | 5.20 | 4.57 |
| 12 | 0.49 | 1.79 | 3.66 | 4.51 |
| 13 | 0.85 | 4.97 | 5.85 | 4.65 |
| 14 | 0.55 | 2.04 | 3.74 | 4.59 |
| 15 | 0.92 | 5.48 | 5.94 | 4.72 |
| 16 | 0.43 | 1.66 | 3.85 | 4.68 |
| 17 | 1.02 | 6.24 | 6.10 | 4.81 |
| 18 | 0.52 | 1.66 | 3.21 | 4.74 |
| 19 | 0.82 | 5.48 | 6.67 | 4.86 |
| 20 | 0.49 | 1.54 | 3.14 | 4.80 |

TABLE 8
Typical results obtained with the IN718
powder at 100 μm layer thickness

| Layer | Volume | Weight | Apparent density | Cumulative density |
|---|---|---|---|---|
| number | (cm³) | (g) | (g/cm³) | (g/cm³) |
| 1 | 1.11 | 12.09 | 10.90 | 10.90 |
| 2 | 1.14 | 5.48 | 4.81 | 4.81 |
| 3 | 1.67 | 8.40 | 5.03 | 4.94 |
| 4 | 1.05 | 3.82 | 3.64 | 4.59 |
| 5 | 1.86 | 9.80 | 5.27 | 4.81 |
| 6 | 1.07 | 4.46 | 4.18 | 4.71 |
| 7 | 1.76 | 10.18 | 5.79 | 4.93 |
| 8 | 1.09 | 4.97 | 4.54 | 4.89 |
| 9 | 1.48 | 9.29 | 6.26 | 5.07 |
| 10 | 1.14 | 5.10 | 4.48 | 5.02 |

### REFERENCES

1. ASTM F2792 2012 Standard Terminology for Additive Manufacturing Technologies (West Conshohocken, Pa.: ASTM International), 2012.
2. Zhu, H., J. Fuh, and L. Lu, Int. J. Mach. Tools Manuf. 2007, Vol. 47, p. 294-298.
3. Drummer, D., M. Drexler, and F. Kühnlein, Phys. Procedia 2010, Vol. 39, p. 500-508.
4. Ziegelmeier, S., et al., J. Mater. Process. Technol. 2015. Vol. 215, p. 239-250.
5. B213-17, Standard Test Methods for Flow Rate of Metal Powders Using the Hall Flowmeter Funnel, ASTM International, West Conshohocken, Pa., 2017, www.astm.org.
6. ASTM B964-16, Standard Test Methods for Flow Rate of Metal Powders Using the Carney Funnel, ASTM International, West Conshohocken, Pa., 2016, www.astm.org.
7. ASTM B212-17, Standard Test Method for Apparent Density of Free-Flowing Metal Powders Using the Hall Flowmeter Funnel, ASTM International, West Conshohocken, Pa., 2017, www.astm.org.
8. ASTM B527-15, Standard Test Method for Tap Density of Metal Powders and Compounds, ASTM International, West Conshohocken, Pa., 2015, www.astm.org.
9. Slotwinski, J. and A. Cook, Properties of Metal Powder for Additive Manufacturing: a Review of the State of the Art of Metal Powder Property Testing. National Institute of Standards and Technology Internal Report (NISTIR) 7873 2012.
10. Granutools. GranuDrum Dynamic Angle of Repose. 2018; Available from: https://granutools.com/.
11. Freeman Technology. FT4 Powder Rheometer. 2018; Available from: www.freemantech.co.uk.
12. Scientific, M. REVOLUTION Powder Analyzer. 2018; Available from: http://www.mercuryscientific.com.
13. Michael Van den Eynde, M., L. Verbelen, and P. Van Puyvelde, Powder Technol. 2015, Vol. 286, p. 151-155.
14. Jacob, G., et al., Meas. Sci. Technol. 2016, Vol. 27(115601), p. 1-12.
15. Liu, B., et al. Investigation the Effect of Particle Size Distribution on Processing Parameters Optimization in Selective Laser Melting Process in Proc. of the Solid Freeform Fabrication Symp. 2011. Austin, Tex.

1. A device for measuring powder bed density (PBD) (powder density for a layer) in additive manufacturing (AM) during operation, the device comprising:
means for determining a mass of the powder and means for determining a volume of the powder during spreading, thereby allowing determination of the powder bed density (powder density for the layer),
wherein the means for determining a volume of the powder comprises a laser assembly adapted to move a laser across a powder layer surface in both left and right directions for scanning.

2. The device according to claim 1, wherein the means for determining the mass of the powder comprises means for measuring a total mass of a system which includes a plate on which the powder is laid and other components of the system, and the mass of the powder is obtained by subtracting a mass of the plate and the other components from the total mass measured.

3. The device according to claim 1, wherein the means for determining the volume of the powder comprises means for measuring a surface area occupied by the powder on a plate on which the powder is laid and means for measuring a thickness of the powder laid, thereby determining the volume of the powder.

4. The device according to claim 3, wherein the thickness of the layer corresponds to a separation distance between the plate on which the powder is laid and another plate of device.

5. The device according to claim 1, wherein the laser allows for measurement of a surface area occupied by the powder on a plate on which the is laid, optionally the surface area occupied by the powder corresponds to a surface of the plate on which the powder is laid.

6. (canceled)

7. The device according to claim 1, wherein the laser assembly is operatively attached to a means for recoating such that during operation, both components move together as one unit.

8. The device according to claim 1, wherein the laser assembly is operatively attached to a means for feeding the powder to the device and a means for recoating such that during operation, all three components move together as one unit.

9. The device according to claim 1, wherein the laser assembly allows for the determination of a layer surface profile, for example a layer roughness, a spreading profile.

10. The device according to claim 1, further comprising a camera placed on a side of the device, which allows for visualization of static and dynamic powder characteristics of processes involved in additive manufacturing such as dynamic flow characteristics of the powder during spreading.

11. The device according to claim 1, further comprising means for allowing any excess powder to be directed to and deposited on catcher plate.

12. The device according to claim 1, wherein:
the means for recoating comprises one or more of a recoater, a roller and a blade; and wherein, during operation, a user selects the recoater, the roller or the blade as desired; and/or
a means for feeding the powder allows for a control of the feeding process, whereby the powder is fed only when necessary; and/or
the laser assembly is further adapted to move up and down above the layer surface.

13. (canceled)

14. (canceled)

15. The device according to claim 1, further comprising a computer system coupled thereto, the computer system having a user interface and allowing for a control of components of the device and for collection of data generated,
optionally the device allows for determination of cumulative density from multiple consecutive layers.

16. (canceled)

17. A device for use in additive manufacturing (AM), the device comprising:
means for determining a mass of the powder for a layer;
means for determining a volume of the powder for the layer during spreading;
a laser assembly adapted to move a laser across the layer surface in both left and right directions, for scanning; and
a computer system operatively coupled to the device,
wherein, during operation, a powder bed density (PBD) (powder density for a layer) and a layer surface profile are determined, and data generated are collected and analyzed; and/or
wherein, during operation, a powder bed density (PBD) (powder density for a layer) and a layer surface profile are determined, static and dynamic powder characteristics of processes involved are visualized, and data generated are collected and analyzed.

18. (canceled)

19. The device according to claim 17, which allows for determination of cumulative density from multiple consecutive layers.

20. (canceled)

21. A system for measuring a volume of power for a layer during operation, in additive manufacturing (AM), the system comprising:
means for measuring, during spreading, a surface area occupied by the powder on a plate on which the powder is laid; and
means for measuring a thickness of the powder layer,
wherein the system comprises a laser assembly adapted to move a laser across a layer surface in both left and right directions for scanning.

22. (canceled)

23. (canceled)

24. A method for measuring power bed density (PBD) (powder density for a layer) in additive manufacturing (AM), the method comprising using the device as defined in claim 1.

25. A method for measuring power bed density (PBD) (powder density for a layer) in additive manufacturing (AM), the method comprising using the system as defined in claim 21.

26. The method according to claim 24, wherein the device is placed in an airtight cage during use.

27. The method according to claim 26, which is performed in an environment comprising inert gas such as argon, partial pressure, vacuum.

28. A method for measuring power bed density (PBD) (powder density for a layer) in additive manufacturing (AM) during operation, the method comprising determining a mass of the powder and determining a volume of the powder during spreading, thereby allowing determination of the powder bed density (powder density for the layer),
wherein determination of the volume of the powder during spreading comprises scanning a powder layer surface using a laser.

29. (canceled)
